(19) United States
(12) Patent Application Publication
(10) Pub. No.: US 2013/0207307 A1
(43) Pub. Date: Aug. 15, 2013

(54) FLEXIBLE PREFORM FOR PRODUCING A PART BASED ON NATURAL FIBERS

(71) Applicant: Marc Depestele, Bivilles-La-Baignarde (FR)

(72) Inventor: Marc Depestele, Bivilles-La-Baignarde (FR)

(73) Assignee: SOCIETE HOLDING DEPESTELE, Cleres (FR)

(21) Appl. No.: 13/808,730

(22) PCT Filed: Jun. 30, 2011
(86) PCT No.: PCT/EP11/61074

§ 371 Date: Feb. 26, 2013

(30) Foreign Application Priority Data
Jul. 7, 2010 (FR) 1055545

(51) Int. Cl. B32B 5/26; B29C 43/12; B29C 43/24; B32B 5/02; B29C 43/20

(52) U.S. Cl. CPC B32B 5/26; B32B 5/022; B32B 5/024; B29C 43/203; B29C 43/24; B29C 43/12
USPC 264/280; 442/268; 442/270; 442/277; 264/324

(57) ABSTRACT

A flexible preform for producing, by heating and shaping, a component based on natural fibres, the preform being including a core made of a nonwoven of natural fibres, at least one surface of which is bonded to a woven fabric made of natural fibres.

### FIELD OF THE INVENTION

The present invention relates to the field of producing rigid parts or components based on natural fibers, and more specifically plant fibers, preferentially flax fibers.

### PRIOR ART

The use of natural, plant and flax fibers for producing materials such as automotive plates or trim parts is known.

International patent application WO03091006 describes a composite material comprising fibrous materials obtained from natural fibers such as flax, and a thermoplastic resin. The method described allows for production by using a spinneret. The method comprises steps of separating the stalk from its capsule, aligning the stalks along the product production line, separating the fibers and wood contained in the stalk and impregnating the fibers with a resin used as a matrix for packing in the form of a flexible yarn or ribbon.

French patent FR2781492 describes a composite thermoplastic material containing fibers of plant origin and a polypropylene matrix.

International patent application WO00/005294 describes a composite thermoplastic material comprising a mixture of a thermoplastic material and hemp fibers with a length of less than or equal to 0.2 mm.

British patent GB2418643 describes a material constituted of a thick layer of a thermoformed material of fibers combined with a layer of aggregated microfibers.

Chinese patent CN 101491947 describes a method of producing a composite material, in particular a method of producing a reinforced woven hemp fabric to form a composite material plate intended for the automotive industry. The material comprises hemp fibers as well as a mixture of epoxy resin and polyamide forming a hardening agent, as well as a diluent.

to British patent GB2460215 describes a material constituted of a thick layer of a thermoformed material of fibers combined with a layer of aggregated microfibers.

Patent EP0671259 describes a laminated multilayer material to produce an internal coating for automobiles, constituted of a support and a decorative outer layer. The support is constituted of a layer forming the core, based on natural fibers, and laminated coating layers.

### DISADVANTAGES OF THE PRIOR ART

The various solutions proposed in the prior art present a first disadvantage relating to industrial implementation.

All of the solutions involve the production on the same site of natural fiber transformation and processing steps to produce the final product, involving equipment and industrial expertise that are very different from those required to transform natural fibers.

The natural fiber transformation steps are preferably implemented near the location where the fibers were cultivated and harvested, to prevent plant materials that are voluminous and sensitive to adverse weather from being transported.

The industrial product preparation steps are more advantageously implemented in shops and production units specific to the intended application.

In addition, methods from the prior art do not optimize the mechanical characteristics of the parts, notably by adjusting the resistance, sound and thermal insulation and surface condition qualities according to the intended usage.

### SOLUTION ACCORDING TO THE INVENTION

The present invention aims to remedy these disadvantages by first proposing a preform constituting a semi-finished material for the preparation, on site and at different times, of industrial parts or components, the properties of which are adjusted to a specific usage.

For this purpose, according to its most general acceptance, the invention relates to a flexible preform for producing, by heating and shaping, a part based on natural fibers, said preform being characterized in that it is constituted of a core made of a nonwoven of natural fibers, at least one surface of which is bonded to a woven fabric made of natural fibers.

This preform may be prepared in the form of rolls or webs delivered to the site where the final parts are produced.

Advantageously, said woven fabric is constituted of webs of natural interwoven fibers that are untwisted. In the prior art, it is customary to twist the fibers to form yarn that is then assembled. Twisting, even moderate twisting, weakens the fibers and reduces strand performance. To prevent this loss of mechanical quality of fiber, the invention consists of using ribbons of aligned fibers, without twisting.

In a first variation, the preform according to the invention is constituted of a core bonded on a single face only to said natural fiber woven fabric.

This preform then enables parts presenting a smooth and rigid surface, and a surface that is possibly fluffy, to be made.

According to a second variation, the preform is constituted of at least one core, the two surfaces of which are bonded to said natural fiber woven fabric.

This variation enables parts or panels to be made, the two outer surfaces of which'are formed of rigid and smooth skins, with a more or less compacted core enabling the sound and thermal insulation, as well as the equivalent thickness, to be adjusted.

According to a preferred embodiment, said natural fibers are flax fibers.

According to a variation, said natural fibers are hemp, sisal, nettle or kenaf plant fibers.

According to a particular variation of embodiment, the woven fabric comprises thermoplastic materials.

Preferably, said thermoplastic materials are polylactic acid, polypropylene or polyamide fibers mixed with said natural fibers.

According to another form of embodiment, said thermoplastic materials are polylactic acid, polypropylene or polyamide powders distributed over said natural fibers.

According to another embodiment, the core made of a nonwoven and the woven fabrics are bonded by needling.

According to another embodiment, the core made of a nonwoven and the woven fabrics are bonded by thermal processing bonding.

Advantageously, the thickness of the core is between 4 millimeters and 10 centimeters.

According to a non-limiting preferential embodiment, the core does not contain a resin to harden the fibers.

The invention also relates to a method to produce a part based on natural fibers, characterized in that a preform constituted of a core made of a nonwoven of natural fibers, at least one surface of which is bonded to a woven fabric made of natural fibers, is heated and compacted.

According to a first variation, the heating and compacting are performed by a mold.

According to a second variation, the heating and compacting are carried out by a membrane and a depressurizing means.

According to a third variation, the heating and compacting are carried out by a calender.

Preferably, the pressure is greater than 1 bar and the temperature is between 160° C. and 270° C.

According to a preferred variation, the method according to the invention does not comprise a pectin extraction step.

The invention also relates to a part based on natural fibers made by heating and compacting a preform constituted of a core made of a nonwoven of natural fibers, at least one surface of which is bonded to a woven fabric made of natural fibers.

Advantageously, said part is produced from a preform constituted of a core, a single surface of which is covered by a woven fabric, for a packaging application.

Preferably, the part is produced by a preform constituted of a core, the two main surfaces of which are covered by a woven fabric, for a structural element application, particularly for automobiles or buildings.

### DETAILED DESCRIPTION OF A NON-LIMITING EXAMPLE OF EMBODIMENT

The invention will be better understood upon reading the following description, relating to a non-limiting example of embodiment, illustrated by appended drawings where:

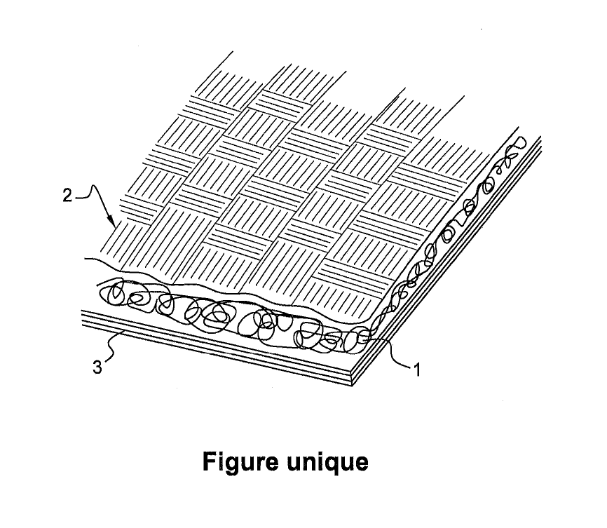

FIG. 1 represents a cross sectional view of a preform according to the invention.

The preform according to the example described is constituted of a web (1) of a nonwoven of flax fibers between two webs (2, 3) of a woven fabric of flax fibers.

The nonwoven web (1) is constituted of a blanket of uncut flax fibers, with a length of approximately one meter. Depending on the intended purpose, this web may be constituted exclusively of flax fibers, or a mixture combining flax fibers and polypropylene fibers, or else fibers based on corn or beet polylactic acid (PLA).

The web presents a thickness of a few centimeters, for example between 1 and 10 centimeters.

The two woven fabric webs (2, 3) are constituted of interweavings of ribbons of uncut flax fibers, aligned in parallel between each other, with a width of a few millimeters. The webs may also combine other fibers such as polypropylene fibers, or else fibers based on polylactic acid (PLA). The fibers are not subjected to twisting so as to conserve the mechanical qualities of long fibers.

The bond between the nonwoven web (1) and the woven fabric webs (2, 3) is carried out by needling.

The preform may be stored and sent in the form of rolls.

The preform is used to produce plates or parts of any form whatsoever. It is possible to form curvatures with small radii. The flax fibers then slide on each other, parallel between each other.

The assembly is then wetted with an aqueous solution of water or water vapor in order to dissolve the pectin surrounding the flax fibers. Heating promotes dissolution and then causes water to evaporate, which leads the pectin to be reconfigured to bind the fibers constituting the woven fabric (2, 3) and nonwoven (1) webs. The assembly is pressurized at pressures of between 1 and 15 bar, which produces compacting of the assembly.

The plates or parts thus produced from preforms according to the invention constitute solid parts enabling trim for automotive, railway or nautical vehicles, packaging, shelves or construction or upholstery materials to be made.

The mold may present ribs applying grooving to the part, thereby enabling hinges without added attachments to be made. The object is to form the woven fabric by leaving a non-polymerized band in the middle to make a hinge.

1. A flexible preform for producing, by heating and shaping, a part based on natural fibers, said preform being constituted of a core made of a nonwoven of natural fibers, at least one surface. of which is bonded to a woven fabric made of natural fibers.

2. The preform according to claim 1, wherein said woven fabric is constituted of webs of natural interwoven fibers that are untwisted.

3. The preform according to claim 1, wherein the preform is constituted of a core bonded on a single face only to said natural fiber woven fabric.

4. The preform according to claim 1, wherein the preform is constituted of a core, the two surfaces of which are bonded to said natural fiber woven fabric.

5. The preform according to claim 1, wherein said natural fibers are flax fibers.

6. The preform according to claim 1, wherein said natural fibers are hemp, sisal, nettle or kenaf plant fibers.

7. The preform according to claim 1, wherein the woven fabric comprises thermoplastic materials.

8. The preform according to claim 7, wherein said thermoplastic materials are polylactic acid, polypropylene or polyamide fibers mixed with said natural fibers.

9. The preform according to claim 7, wherein said thermoplastic materials are polylactic acid, polypropylene or polyamide powders distributed over said natural fibers.

10. The preform according to claim 1, wherein the core made of a nonwoven and the woven fabrics are bonded by needling.

11. The preform according to claim 1, wherein the core made of a nonwoven and the woven fabrics are bonded by thermal processing bonding.

12. The preform according to claim 1, wherein the thickness of the core is between 4 millimeters and 10 centimeters.

13. A method to produce a part based on natural fibers, comprising bonding at least one surface of a preform constituted of a core made of a nonwoven of natural fibers to a woven fabric made of natural fibers, and heating and compacting the preform.

14. The method to produce a part based on natural fibers according to claim 13, wherein the heating and compacting are carried out by a mold.

15. The method to produce a part based on natural fibers according to claim 13, wherein the heating and compacting are carried out by a membrane and a depressurizing means.

16. The method to produce a part based on natural fibers according to claim 13, wherein the heating and compacting are carried out by a calender.

17. The method to produce a part based on natural fibers according to claim 13, wherein the pressure is greater than 1 bar and the temperature is between 160° C. and 270° C.

18. The method to produce a part based on natural fibers according to claim 13, wherein the method does not comprise a pectin extraction step.

19. A part based on natural fibers made by heating and compacting a preform constituted of a core made of a nonwoven made of natural fibers, at least one surface of which is bonded to a natural fiber woven fabric.

20. The part according to claim 19, wherein the part is produced from a preform constituted of a core, a single surface of which is covered by a woven fabric, for a packaging application.

21. The part according to claim 19, wherein the part is produced from a preform constituted of a core, the two main surfaces of which are covered by a woven fabric, for a structural element application, particularly for automobiles or buildings.
